(19) United States
(12) Patent Application Publication
(10) Pub. No.: US 2019/0338894 A1
(43) Pub. Date: Nov. 7, 2019

(54) BULB HOLDER STRUCTURE

(71) Applicant: MAINHOUSE (XIAMEN) ELECTRONICS CO., LTD, Xiamen City, Fujian (CN)

(72) Inventors: Nanqing ZHOU, Xiamen City (CN); Rongkui WU, Xiamen City (CN)

(73) Assignee: Mainhouse (Xiamen) Electronics Co., Ltd, Xiamen City, Fujian (CN)

(21) Appl. No.: 16/324,894

(22) PCT Filed: Sep. 27, 2016
(86) PCT No.: PCT/CN2016/100237

§ 371 Date: Feb. 11, 2019

(51) Int. Cl. F21K 9/237; F21V 15/01

(52) U.S. Cl. CPC F21K 9/237; F21V 15/01

(57) ABSTRACT

A bulb holder structure includes a bulb holder, and a housing and a thermally conductive member fitting to the bulb holder. A protruding ring formed on an inner surface of the housing fits an annular base on a lower portion of the thermally conductive member. A plurality of protruding portions are peripherally distributed on an inner surface of the ring. An inner diameter defined by the protruding portions is smaller than an outer diameter of the base, that is, the ring forms an interference fit with the base of the thermally conductive member through the protruding portions, thereby effectively improving fit stability between the thermally conductive member and the housing, boosting yield, and ensuring excellent heat dissipation.

### BACKGROUND OF THE INVENTION

### 1. Field of the Invention

The present invention relates to the field of illumination, and more particularly to a bulb holder structure.

### 2. Description of the Prior Art

An LED is a semiconductor device that directly converts electricity into light. An LED has many advantages such as small size, low power consumption, long service life, high brightness, low heat generated, environmental protection, and durability. This makes an LED light source have obvious advantages compared with a conventional light source, so the LED light source is widely used. The surface area of the LED chip is small, and the current density is high during operation. It is often required to combine a plurality of LEDs for illumination. The density of LEDs is great, resulting in high heat generation density of the chip. As the junction temperature rises, the light output is reduced, the chip is degenerated, and the service life of the device is shortened. Therefore, a heat dissipation structure must be provided to ensure the normal use of the LED bulb.

As shown in FIG. 1 and FIG. 2, the heat dissipation structure of a conventional LED bulb includes a thermally conductive member 4′ for transmitting heat to a housing 2′ made of a plastic material. Then, the heat is transmitted to a bulb holder 3′. The thermally conductive member 4′ is attached to the housing 2′. However, since the thermally conductive member 4′ is made of a metal material, it is not easily deformed. The housing 2′ is made of a plastic material, and it is easily deformed by heat. In addition, during the manufacturing process, the thermally conductive member 4′ and the housing 2′ have a certain tolerance. The assembly of the thermally conductive member 4′ and the outer casing 2′ is done by an interference fit, so the housing 2′ may be broken by the force of the thermally conductive member 4′, which affects the yield of the product. There may be a gap in the assembly of the thermally conductive member 4′ and the housing 2′, resulting in a decrease in conductivity between the thermally conductive member 4′ and the housing 2′ to affect heat dissipation.

In addition, heat is transmitted to the housing 2′ made of the plastic material via the thermally conductive member 4′ for heat dissipation, and the way for heat dissipation is single. In order to ensure heat dissipation efficiency, the housing 2′ is generally large in area. As a result, the shape of the LED bulb is greatly different from that of a conventional bulb.

Accordingly, the inventor of the present invention has devoted himself based on his many years of practical experiences to solve these problems.

### SUMMARY OF THE INVENTION

The primary object of the present invention is to provide a bulb holder structure which can improve the fit stability of the thermally conductive member and the housing of the heat dissipation structure and ensure the heat dissipation performance of the bulb body.

Another object of the present invention is to provide a bulb holder structure which can further improve the heat dissipation efficiency of the bulb body.

In order to achieve the above object, the present invention adopts the following solutions.

A bulb holder structure comprises a lamp holder, a housing and a thermally conductive member fitting to the housing. A protruding ring formed on an inner surface of the housing fits an annular base on a lower portion of the thermally conductive member. A plurality of protruding portions are peripherally disposed on an inner surface of the ring. An inner diameter defined by the protruding portions is smaller than an outer diameter of the base. The ring forms an interference fit with the base of the thermally conductive member through the protruding portions.

The protruding portions are pointed.

The protruding portions are wavy.

An underside of the base of the thermally conductive member has a plurality of spaced heat-conductive plates extending downwardly. The housing is provided with engaging grooves corresponding to the heat-conductive plates.

The engaging grooves are located at a joint between the housing and the bulb holder.

Each of the heat-conductive plates is a T-shaped heat-conductive plate.

The heat-conductive plates are an integral annular configuration.

An upper portion of the thermally conductive member is a hollow configuration to form a cavity.

By adopting the above solutions, because the inner diameter defined by the protruding portions on the inner surface of the ring is smaller than the outer diameter of the base, the base and the ring are insertedly connected to each other. During an insertion process, because of a small force bearing area on the top of the protruding portions and gaps between the protruding portions, the base presses on the protruding portions to deform the protruding portions such that the gaps between the protruding portions are filled with deformed mold flashes, the ring completely presses the base of the thermally conductive member to ensure that there is no gap at the joint between the housing and the thermally conductive member and to form an easy and secure fit, thereby effectively improving fit stability between the housing and the thermally conductive member and boosting yield.

In addition, the thermally conductive member is inserted and mated with the housing to ensure an effective contact area of the two, so that the heat of the thermally conductive member is transmitted to the housing as much as possible, ensuring excellent heat dissipation of a bulb body.

Furthermore, the underside of the base of the thermally conductive member has the plurality of heat-conductive plates extending downwardly. The heat-conductive plates are separated from the bulb holder by a layer of plastic housing. Through the heat-conductive plates, the distance between the thermally conductive member and the bulb holder is reduced. When the LED bulb is turned on, the heat generated by the chips is transmitted to the thermally conductive member. Because the heat-conductive plates are close to the bulb holder, the heat can be transmitted to the bulb holder quickly, and then the heat is transmitted to the bulb holder seat by the bulb holder, so that the heat of the chips is dissipated quickly, improving the heat dissipation efficiency of the bulb body and providing a better heat dissipation effect.

### BRIEF DESCRIPTION OF THE DRAWINGS

FIG. 1 is a cross-sectional view showing an interference fit between the housing and the thermally conductive member of the conventional LED bulb;

FIG. 2 is another cross-sectional view showing an interference fit between the housing and the thermally conductive member of the conventional LED bulb;

FIG. 3 is an exploded view of the present invention;

FIG. 4 is a partially exploded view of the present invention;

FIG. 5 is a cross-sectional view of the pointed protruding portions of the ring of the housing of the present invention;

FIG. 6 is a cross-sectional view of the wavy protruding portions of the ring of the housing of the present invention; and

FIG. 7 is a cross-sectional of the present invention.

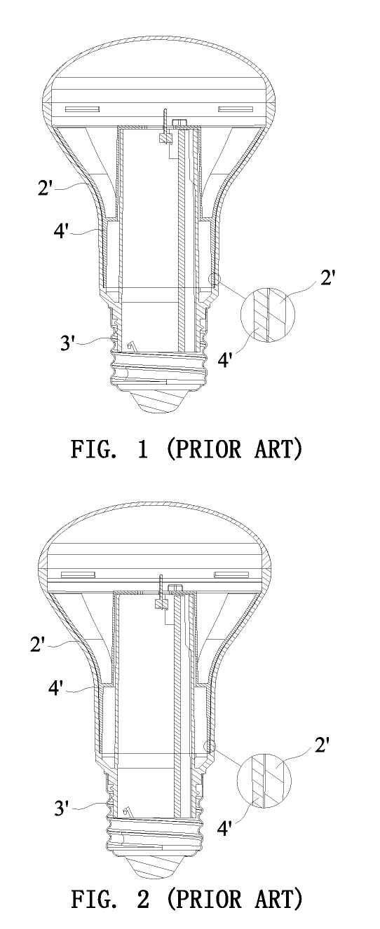

### DETAILED DESCRIPTION OF THE PREFERRED EMBODIMENTS

Embodiments of the present invention will now be described, by way of example only, with reference to the accompanying drawings.

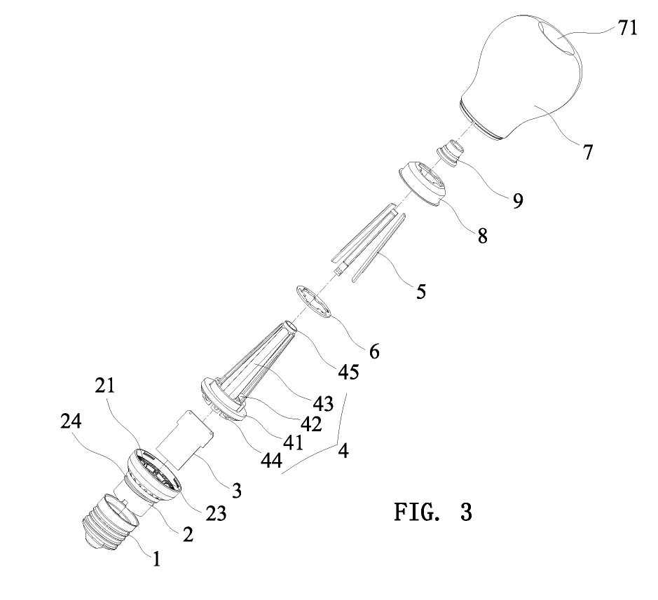

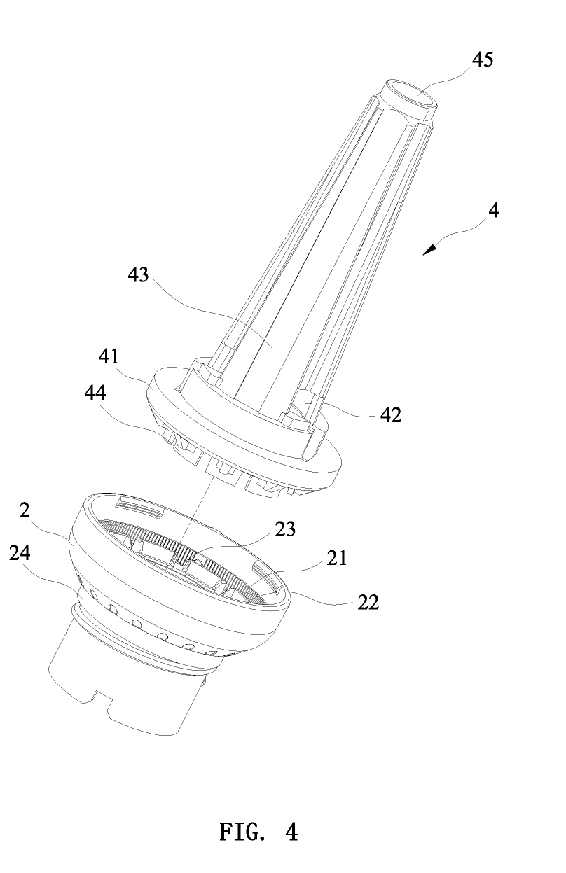

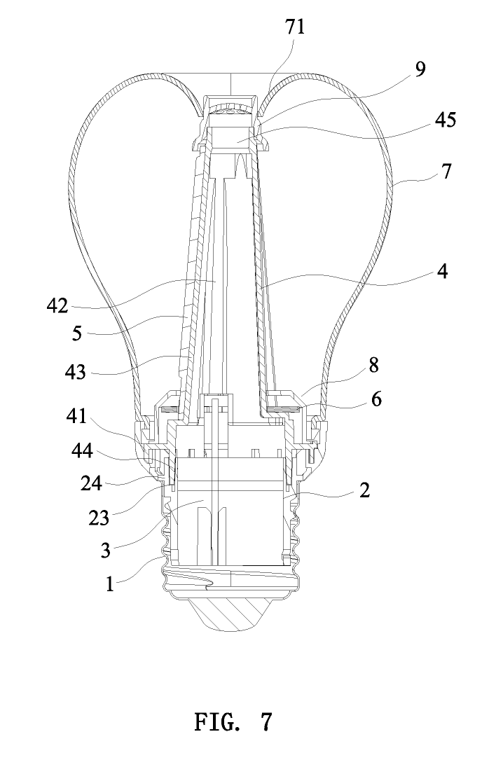

As shown in FIG. 2 through FIG. 7, the present invention discloses a bulb holder structure applied to an LED bulb. The LED bulb comprises a lamp holder 1, a housing 2 fitting to the lamp holder 1, a circuit board 3 for driving LED chips to work, a thermally conductive member 4 fitting to the housing 2, a plurality of chips 5 having LEDs mounted on the thermally conductive member 4, a double-sided panel 6 connected to the chips 5 and the circuit board 3, and a casing 7 disposed outside the thermally conductive member 4 and the chips 5.

The lower end of the thermally conductive member 4 is formed with an annular base 41 fitted in the housing 2. The upper portion of the thermally conductive member 4 is a hollow configuration to form a cavity 42. The cavity 42 is gradually reduced from bottom to top to form a vent 45. The outer wall of the cavity 42 is provided with spaced substrates 43 corresponding to the chips 5 for the chips 5 to be placed on the thermally conductive member 4. The upper ends of the substrates 43 are sleeved with a connecting sleeve 9. The upper portion of the connecting sleeve 9 is inserted in a top opening 71 of the casing 7. The circuit board 3 is longitudinally inserted into the housing 2. The upper end of the circuit board 3 is abutted against the thermally conductive member 4, and the lower end of the circuit board 3 is connected to the lamp holder 1. The double-sided panel 6 is disposed on the upper part of the annular base 41 and connected with the chips 5 and the circuit board 3. A cover 8 is disposed above the double-sided panel 6. The casing 7 is configured to cover the chips 5 and is connected to the housing 2.

A protruding ring 21 formed on an inner surface of the housing 2 fits an annular base 41 on a lower portion of the thermally conductive member 4. A plurality of protruding portions 22 are peripherally disposed on an inner surface of the ring 21. An inner diameter defined by the protruding portions 22 is smaller than an outer diameter of the base 41, that is, the ring 21 forms an interference fit with the base 41 of the thermally conductive member 4 through the protruding portions 22.

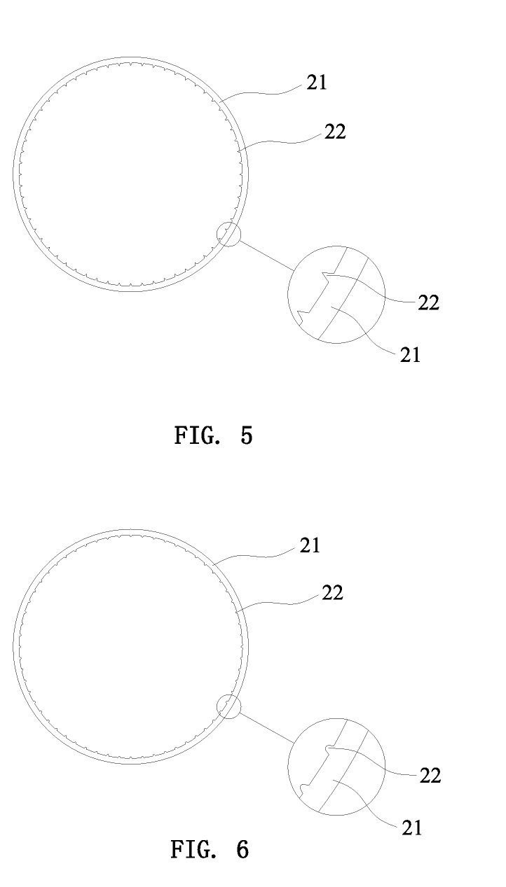

As shown in FIG. 5, the protruding portions 22 are preferably pointed. As shown in FIG. 6, the protruding portions 22 are wavy.

When the housing 2 and the thermally conductive member 4 are assembled, because the inner diameter defined by the protruding portions 22 on the inner surface of the ring 21 is smaller than the outer diameter of the base 41, the base 41 and the ring 21 are insertedly connected to each other. During an insertion process, because of a small force bearing area on the top of the protruding portions 22 and gaps between the protruding portions 22, the base 41 presses on the protruding portions 22 to deform the protruding portions 22 such that the gaps between the protruding portions 22 are filled with deformed mold flashes, the ring 21 completely presses the base 41 of the thermally conductive member 4, ensuring that there is no gap at the joint between the housing 2 and the thermally conductive member 4 and forming an easy and secure fit. Through the arrangement of the protruding portions 22, it is easy to control the process tolerance of the housing 2. The housing 2 is less likely to be broken, thereby effectively improving fit stability between the housing 2 and the thermally conductive member 4 and boosting yield. In addition, the thermally conductive member 4 is inserted to and matched with the housing 2 to ensure an effective contact area of the two, so that the heat of the thermally conductive member 4 is transmitted to the housing 2 as much as possible, ensuring excellent heat dissipation of a bulb body.

In addition, the underside of the base 41 of the thermally conductive member 4 made of a metal material further has a plurality of spaced heat-conductive plates 44 extending downwardly. The housing 2 is provided with engaging grooves 23 corresponding to the heat-conductive plates 44.

The engaging grooves 23 may be located at the joint 24 of the housing 2 and the bulb holder 1.

Each of the heat-conductive plates 44 is a T-shaped heat-conductive plate to increase its surface area.

Of course, the heat-conductive plates 44 are an integral annular configuration, which further increases the contact area with the housing 2.

When assembled, the heat-conductive plates 44 are completely inserted into the engaging grooves 23, and the heat-conductive plates 44 are separated from the bulb holder 1 by a layer of plastic housing. Through the heat-conductive plates 44, the distance between the thermally conductive member 4 and the bulb holder 1 is reduced. When the LED bulb is turned on, the heat generated by the chips 5 is transmitted to the thermally conductive member 4. Because the heat-conductive plates 44 are close to the bulb holder 1, the heat can be transmitted to the bulb holder 1 quickly, and then the heat is transmitted to the bulb holder seat by the bulb holder 1, so that the heat of the chips 5 is dissipated quickly.

The present invention forms convective heat dissipation by using the hollow cavity 42 of the thermally conductive member on the basis of the heat dissipation by the existing housing 2. Furthermore, the heat-conductive plates 44 are configured to quickly transmit heat to the lamp holder 1, and then the heat is dissipated by the bulb holder seat. The heat is dissipated in different ways to improve the heat dissipation efficiency, so the heat dissipation effect is better.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A bulb holder structure, comprising a lamp holder, a housing and a thermally conductive member fitting to the housing; a protruding ring formed on an inner surface of the housing fitting an annular base on a lower portion of the thermally conductive member, a plurality of protruding portions being peripherally disposed on an inner surface of the ring, an inner diameter defined by the protruding portions being smaller than an outer diameter of the base, the ring forming an interference fit with the base of the thermally conductive member through the protruding portions.

2. The bulb holder structure as claimed in claim 1, wherein the protruding portions are pointed.

3. The bulb holder structure as claimed in claim 1, wherein the protruding portions are wavy.

4. The bulb holder structure as claimed in claim 1, 2 or 3, wherein an underside of the base of the thermally conductive member has a plurality of spaced heat-conductive plates extending downwardly, and the housing is provided with engaging grooves corresponding to the heat-conductive plates.

5. The bulb holder structure as claimed in claim 4, wherein the engaging grooves are located at a joint between the housing and the bulb holder.

6. The bulb holder structure as claimed in claim 4, wherein each of the heat-conductive plates is a T-shaped heat-conductive plate.

7. The bulb holder structure as claimed in claim 4, wherein the heat-conductive plates are an integral annular configuration.

8. The bulb holder structure as claimed in claim 4, wherein an upper portion of the thermally conductive member is a hollow configuration to form a cavity.
